(19) United States
(12) Patent Application Publication
(10) Pub. No.: US 2018/0134070 A1
(43) Pub. Date: May 17, 2018

(54) Production Method of Pseudo-wood and Pseudo-stone Furniture or Ornament Material with Natural Grains

(71) Applicant: Zhi-Feng Ning, Chizhou City (TW)

(72) Inventor: Zhi-Feng Ning, Chizhou City (TW)

(21) Appl. No.: 15/352,644

(22) Filed: Nov. 16, 2016

(51) Int. Cl. B44C 5/06; B29C 33/38; B28B 1/52; B28B 7/34; B28B 7/38; B28B 17/02; B28B 11/04; B44F 9/02; B44F 9/04

(52) U.S. Cl. CPC B44C 5/06; B29C 33/3857; B28B 1/52; B28B 7/346; B28B 7/348; B29K 2903/04; B28B 17/02; B28B 11/04; B44F 9/02; B44F 9/04; B28B 7/384

(57) ABSTRACT

A production method of pseudo-wood and pseudo-stone furniture or ornament material with natural grains has a characteristic in that, the magnesia, the magnesium chloride, the water and the glass fiber are used to function as the primary staple. Then, a determined amount of modifier, sawdust powder and talcum powder is added into the primary staple. Then, the mold and the framework are operated according to the determined steps. Then, the primary staple is shaped. Then, the primary staple performs an oxidation process to form the product. Thus, the product is directly manufactured by the mold, without needing multiple and complicated working steps.

### BACKGROUND OF THE INVENTION

### 1. Field of the Invention

The present invention relates to a production method and, more particularly, to a production method of pseudo-wood and pseudo-stone furniture or ornament material with natural grains.

### 2. Description of the Related Art

A conventional method for making furniture or wooden ornament material comprises using a machine to work the wood material into many parts. Then, the parts are bonded by glue. Then, the parts are secured by screws and bolts. Finally, paint is sprayed on the parts to produce the furniture or ornament material. However, such a method for making furniture or wooden ornament material has complicated working procedures, needs a large amount of wood material, and has a high cost of fabrication. In addition, a large amount of waste material is produced during the manufacturing process, thereby causing consumption of the forest source, and polluting the ecology and the environment.

### BRIEF SUMMARY OF THE INVENTION

The primary objective of the present invention is to provide a production method of pseudo-wood and pseudo-stone furniture or ornament material with natural grains.

In accordance with the present invention, there is provided a production method of pseudo-wood and pseudo-stone furniture or ornament material with natural grains, comprising:

(1) providing wood and stone with natural grains, or furniture or ornament material made of designed wood and stone with natural grains, to function as a model of production;

(2) mixing and evenly stirring silica gel and a hardener to form a mixture, then brushing the mixture on the model evenly, then spreading a gauze, then brushing the mixture again, and repeating three times during 4-10 hours until the silica gel has a thickness reaching 5-10 mm, to cure and form an interior mold of production;

(3) using resin to make an exterior mold on the interior mold which is cured, with the exterior mold having a shaping function;

(4) adding a modifier with a mass proportion of 1-8% into a magnesium chloride solution with 15-35 Baume degrees, and mixing and stirring evenly to form a magnesium chloride mixture solution;

(5) mixing magnesia with the magnesium chloride mixture solution according to a mass proportion of 1-2:1, then adding sawdust powder, glass fiber and talcum powder, with a mass proportion of 10-20%, and placing the above substances into a blender and blending to form a paste mixture;

(6) removing the model, then wiping a layer of release agent on the interior mold and the exterior mold, then adding the paste mixture in the interior mold, then spreading one layer or two layers of fiber felt, then trimming flat, then brushing the paste mixture, then trimming flat again, and placing a framework and shaping, to make magnesia furniture or ornament material with a thickness of 5-10 mm;

(7) drying the magnesia furniture or ornament material during 2-8 hours, then stripping, then placing the magnesia furniture or ornament material on a platform or in a drying space to perform an oxidation process during 7-30 days, and trimming the magnesia furniture or ornament material to a determined extent;

(8) using a water-based paint to prepare proper colors according to the natural grains of the magnesia furniture or ornament material, and manually coloring the magnesia furniture or ornament material to make required colors; and

(9) providing legs and bases under the magnesia furniture or ornament material, to assemble and produce furniture or ornament material with natural grains.

Preferably, in the step (2), the silica gel has a mass proportion of 3-5% in the mixture, and the hardener has a mass proportion of 95-97% in the mixture.

Preferably, in the step (4), the modifier is prepared by a group of substances including: potassium carbonate with a mass proportion of 10-20%, aluminum sulfate with a mass proportion of 10-20%, silicon dioxide with a mass proportion of 30-50%, ferrous sulfate with a mass proportion of 10-20%, phosphoric acid with a mass proportion of 5-10%, oxalic acid with a mass proportion of 5-10%, ferric oxide with a mass proportion of 5-10% and aluminum oxide with a mass proportion of 5-10%; and the step (4) further includes using water to dilute the prepared modifier to have 15-35 Baume degrees.

Preferably, in the step (5), the mass proportion of the sawdust powder, the glass fiber and the talcum powder is 1:1:1.

Preferably, in the step (6), the release agent is floor wax or detergent.

Preferably, in the step (6), the framework is made of iron or wood.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

No drawing is applied.

### DETAILED DESCRIPTION OF THE INVENTION

A production method of pseudo-wood and pseudo-stone furniture or ornament material with natural grains in accordance with the present invention comprises:

(1) providing wood and stone with natural grains, or furniture or ornament material made of designed wood and stone with natural grains, to function as a model of production;

(2) mixing and evenly stirring silica gel and a hardener to form a mixture, then brushing the mixture on the model evenly, then spreading a gauze, then brushing the mixture again, and repeating three times during 4-10 hours until the silica gel has a thickness reaching 5-10 mm, to cure and form an interior mold of production;

(3) using resin to make an exterior mold on the interior mold which is cured, with the exterior mold having a shaping function;

(4) adding a modifier with a mass proportion of 1-8% into a magnesium chloride solution with 15-35 Baume degrees, and mixing and stirring evenly to form a magnesium chloride mixture solution;

(5) mixing magnesia with the magnesium chloride mixture solution according to a mass proportion of 1-2:1, then adding sawdust powder, glass fiber and talcum powder, with a mass proportion of 10-20%, and placing the above substances into a blender and blending to form a paste mixture;

(6) removing the model, then wiping a layer of release agent on the interior mold and the exterior mold, then adding the paste mixture in the interior mold, then spreading one layer or two layers of fiber felt, then trimming flat, then brushing the paste mixture, then trimming flat again, and placing a framework and shaping, to make magnesia furniture or ornament material with a thickness of 5-10 mm;

(7) drying the magnesia furniture or ornament material during 2-8 hours, then stripping, then placing the magnesia furniture or ornament material on a platform or in a drying space to perform an oxidation process during 7-30 days, and trimming the magnesia furniture or ornament material to a determined extent;

(8) using a water-based paint to prepare proper colors according to the natural grains of the magnesia furniture or ornament material, and manually coloring the magnesia furniture or ornament material to make required colors; and

(9) providing legs and bases under the magnesia furniture or ornament material, to assemble and produce furniture or ornament material with natural grains.

In the step (2), the silica gel and the hardener are mixed according to a determined proportion. Preferably, the silica gel has a mass proportion of 3-5% in the mixture, and the hardener has a mass proportion of 95-97% in the mixture. In addition, the mixture is applied on the model by a brush.

In the step (4), the modifier is prepared by a group of substances including: potassium carbonate with a mass proportion of 10-20%, aluminum sulfate with a mass proportion of 10-20%, silicon dioxide with a mass proportion of 30-50%, ferrous sulfate with a mass proportion of 10-20%, phosphoric acid with a mass proportion of 5-10%, oxalic acid with a mass proportion of 5-10%, ferric oxide with a mass proportion of 5-10% and aluminum oxide with a mass proportion of 5-10%. In addition, the step (4) further includes using water to dilute the modifier that has been prepared to have 15-35 Baume degrees.

In the step (5), the mass proportion of the sawdust powder, the glass fiber and the talcum powder is 1:1:1. In addition, the glass fiber provides a reinforcing function.

In the step (6), the framework is made of iron or wood. In addition, a simple ornament does not need the framework. In addition, the release agent is floor wax or detergent.

In the step (9), the legs and bases are made of iron or wood and are designed professionally.

In the preferred embodiment of the present invention, the production method of pseudo-wood and pseudo-stone furniture or ornament material with natural grains in accordance with the preferred embodiment of the present invention comprises:

(1) providing wood and stone with natural grains, or furniture or ornament material made of designed wood and stone with natural grains, to function as the model of production;

(2) mixing and evenly stirring the silica gel and the hardener according to a determined proportion to form the mixture (the silica gel has a mass proportion of 3-5% in the mixture, and the hardener has a mass proportion of 95-97% in the mixture), then using the brush to brush the mixture on the model evenly, then spreading the gauze, then brushing the mixture again, and repeating three times during 4-10 hours until the silica gel has a thickness reaching 9-10 mm, to cure and form the interior mold of production;

(3) using the resin to make the exterior mold on the interior mold which is cured, with the exterior mold having a shaping function;

(4) adding water into the magnesium chloride at the normal temperature to prepare the magnesium chloride solution of 20 Baume degrees, with the magnesium chloride solution being prepared one day before production;

adding the modifier with a mass proportion of 5% into the magnesium chloride solution, using water to dilute the modifier to have 20 Baume degrees, and mixing and stirring evenly to form the magnesium chloride mixture solution;

the modifier being prepared by the group of substances including: potassium carbonate with a mass proportion of 10%, aluminum sulfate with a mass proportion of 10%, silicon dioxide with a mass proportion of 40%, ferrous sulfate with a mass proportion of 10%, phosphoric acid with a mass proportion of 8%, oxalic acid with a mass proportion of 8%, ferric oxide with a mass proportion of 7% and aluminum oxide with a mass proportion of 7%;

(5) mixing the magnesia with the magnesium chloride mixture solution according to a mass proportion of 1.8:1, then adding the sawdust powder, the glass fiber and the talcum powder, with a mass proportion of 15%, and placing the above substances into the blender and blending to form the paste mixture;

the mass proportion of the sawdust powder, the glass fiber and the talcum powder being 1:1:1;

(6) removing the model, then wiping a layer of release agent on the interior mold and the exterior mold, then adding the paste mixture in the interior mold, then spreading one layer or two layers of fiber felt, then trimming flat, then brushing the paste mixture, then trimming flat again, and placing the iron framework (a simple ornament does not need the framework) and shaping, to make magnesia furniture or ornament material with a thickness of 8-9 mm;

(7) drying the magnesia furniture or ornament material during 8 hours, then stripping, then placing the magnesia furniture or ornament material on the platform or in the drying space to perform an oxidation process during about 10 days (the magnesia furniture or ornament material is placed on the platform during about 30 days if the temperature is too low), and trimming the magnesia furniture or ornament material to the determined extent;

(8) using the water-based paint to prepare proper colors according to the natural grains of the magnesia furniture or ornament material, and manually coloring the magnesia furniture or ornament material to make required colors; and

(9) providing legs and bases, made of iron or wood and designed professionally, under the panel of the magnesia furniture or ornament material that is colored, to assemble and produce the product of the furniture or ornament material with natural grains.

In conclusion, the characteristic of the present invention is in that, the magnesia, the magnesium chloride, the water and the glass fiber are the primary staple. Then, a determined amount of modifier, sawdust powder and talcum powder is added into the primary staple. Then, the mold and the framework are operated according to the determined steps. Then, the primary staple is shaped. Then, the primary staple performs an oxidation process to form the product.

Accordingly, the product is directly manufactured by the mold, without needing multiple and complicated working steps, thereby simplifying the making procedures, reducing the working time, and decreasing the cost of fabrication. In addition, the product contains the natural grains of wood or stone without needing special sculpture, thereby saving the manual labor, and enhancing the aesthetic quality of the product. Further, the product only uses little wood material, thereby largely reducing consumption of the forest source, and protecting the ecological environment. Further, the product does not contain any harmful substance, such as benzene, formaldehyde or the like so that it will not do harm to the user. Further, the product is waterproof, dampproof, mothproof and mildewproof, and is not distorted or deformed. Further, the product has heat isolating, soundproof and electricity insulating functions.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A production method of pseudo-wood and pseudo-stone furniture or ornament material with natural grains, comprising:
(1) providing wood and stone with natural grains, or furniture or ornament material made of designed wood and stone with natural grains, to function as a model of production;
(2) mixing and evenly stirring silica gel and a hardener to form a mixture, then brushing the mixture on the model evenly, then spreading a gauze, then brushing the mixture again, and repeating three times during 4-10 hours until the silica gel has a thickness reaching 5-10 mm, to cure and form an interior mold of production;
(3) using resin to make an exterior mold on the interior mold which is cured, with the exterior mold having a shaping function;
(4) adding a modifier with a mass proportion of 1-8% into a magnesium chloride solution with 15-35 Baume degrees, and mixing and stirring evenly to form a magnesium chloride mixture solution;
(5) mixing magnesia with the magnesium chloride mixture solution according to a mass proportion of 1-2:1, then adding sawdust powder, glass fiber and talcum powder, with a mass proportion of 10-20%, and placing the above substances into a blender and blending to form a paste mixture;
(6) removing the model, then wiping a layer of release agent on the interior mold and the exterior mold, then adding the paste mixture in the interior mold, then spreading one layer or two layers of fiber felt, then trimming flat, then brushing the paste mixture, then trimming flat again, and placing a framework and shaping, to make magnesia furniture or ornament material with a thickness of 5-10 mm;
(7) drying the magnesia furniture or ornament material during 2-8 hours, then stripping, then placing the magnesia furniture or ornament material on a platform or in a drying space to perform an oxidation process during 7-30 days, and trimming the magnesia furniture or ornament material to a determined extent;
(8) using a water-based paint to prepare proper colors according to the natural grains of the magnesia furniture or ornament material, and manually coloring the magnesia furniture or ornament material to make required colors; and
(9) providing legs and bases under the magnesia furniture or ornament material, to assemble and produce furniture or ornament material with natural grains.

2. The production method of pseudo-wood and pseudo-stone furniture or ornament material with natural grains of claim 1, wherein in the step (2), the silica gel has a mass proportion of 3-5% in the mixture, and the hardener has a mass proportion of 95-97% in the mixture.

3. The production method of pseudo-wood and pseudo-stone furniture or ornament material with natural grains of claim 1, wherein:
in the step (4), the modifier is prepared by a group of substances including: potassium carbonate with a mass proportion of 10-20%, aluminum sulfate with a mass proportion of 10-20%, silicon dioxide with a mass proportion of 30-50%, ferrous sulfate with a mass proportion of 10-20%, phosphoric acid with a mass proportion of 5-10%, oxalic acid with a mass proportion of 5-10%, ferric oxide with a mass proportion of 5-10% and aluminum oxide with a mass proportion of 5-10%; and
the step (4) further includes using water to dilute the prepared modifier to have 15-35 Baume degrees.

4. The production method of pseudo-wood and pseudo-stone furniture or ornament material with natural grains of claim 1, wherein in the step (5), the mass proportion of the sawdust powder, the glass fiber and the talcum powder is 1:1:1.

5. The production method of pseudo-wood and pseudo-stone furniture or ornament material with natural grains of claim 1, wherein in the step (6), the release agent is floor wax or detergent.

6. The production method of pseudo-wood and pseudo-stone furniture or ornament material with natural grains of claim 1, wherein in the step (6), the framework is made of iron or wood.
